(19) United States
(12) Patent Application Publication
(10) Pub. No.: US 2011/0314426 A1
(43) Pub. Date: Dec. 22, 2011

(54) RISK-BASED ALERTS

(75) Inventors: Bjorn Markus Jakobsson, Mountain View, CA (US); Philippe J.P. Golle, San Francisco, CA (US)

(73) Assignee: PALO ALTO RESEARCH CENTER INCORPORATED, Palo Alto, CA (US)

(21) Appl. No.: 12/818,168

(22) Filed: Jun. 18, 2010

(51) Int. Cl. G06F 3/033

(52) U.S. Cl. 715/863

(57) ABSTRACT

Some embodiments provide a system that facilitates use of a computer system. During operation, the system obtains notification of a risk associated with a user action on the computer system. Next, the system generates an alert within a user interface based at least on a severity of the risk. The alert may include a set of user-interface elements representing an effect of the user action. The system then receives a response to the alert from a user of the computer system. The response may include a dragging of a first of the user-interface elements in one or more directions to a second of the user-interface elements. Finally, the system processes the user action based at least on the response.

### BACKGROUND

1. Field

The present embodiments relate to alerts within a user interface. More specifically, the present embodiments relate to a method and system for generating an alert based at least on the severity of a risk associated with a user action on a computer system.

2. Related Art

User interfaces typically include alerts associated with risky user actions on computer systems. For example, a web browser may alert a user before the user installs a potentially dangerous application and/or visits a website that is believed to be harmful. Moreover, such alerts generally do not prevent the user from carrying out his/her action; instead, the alerts may warn the user of the potential risk of the user actions. For example, an alert may require the user to click a button, copy and paste a Uniform Resource Locator (URL) into a field, and/or otherwise interact with the user interface to continue with a risky user action.

However, such alerts may not distinguish between different kinds of risks. For example, all alerts generated by a web browser may require the user to select a button to proceed with the corresponding user actions, regardless of the severity of the risk associated with each user action. As a result, the user may become habituated to the appearance of an alert and proceed with the corresponding action, even if the action installs malware on the computer system, causes sensitive and/or personal information to be transmitted to a third party, and/or crashes the computer system.

Hence, risks associated with user actions on computer systems may be mitigated by reducing user habituation to alerts for the risks.

### SUMMARY

Some embodiments provide a system that facilitates use of a computer system. During operation, the system obtains notification of a risk associated with a user action on the computer system. Next, the system generates an alert within a user interface based at least on a severity of the risk. The alert may include a set of user-interface elements representing an effect of the user action. The system then receives a response to the alert from a user of the computer system. The response may include a dragging of a first of the user-interface elements in one or more directions to a second of the user-interface elements. Finally, the system processes the user action based at least on the response.

In some embodiments, generating the alert based at least on the severity of the risk involves displaying the user-interface elements to the user, and prompting the user to drag the first of the user-interface elements in the one or more directions to the second of the user-interface elements.

In some embodiments, the one or more directions include a common direction, a non-common direction, or a sequence of directions.

In some embodiments, generating the alert based at least on the severity of the risk further involves prompting the user to drag the first of the user-interface elements in one or more directions to a third of the user-interface elements.

In some embodiments, the second of the user-interface elements represents a completion of the user action, and the third of the user-interface elements represents a discontinuation of the user action.

In some embodiments, processing the user action based at least on the response involves completing the user action if the second of the user-interface elements represents a completion of the user action, and discontinuing the user action if the second of the user-interface elements represents a discontinuation of the user action.

In some embodiments, the user interface corresponds to a graphical user interface (GUI), a touch user interface, or a voice user interface.

### BRIEF DESCRIPTION OF THE FIGURES

FIG. 1 shows a computer system in accordance with an embodiment.

FIG. 2A shows an exemplary screenshot in accordance with an embodiment.

FIG. 2B shows an exemplary screenshot in accordance with an embodiment.

FIG. 3 shows an exemplary screenshot in accordance with an embodiment.

FIG. 4 shows an exemplary screenshot in accordance with an embodiment.

FIG. 5 shows a flowchart illustrating the process of facilitating use of a computer system in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

Embodiments provide a method and system for generating alerts within a user interface. The user interface may correspond to a graphical user interface (GUI), a touch user interface, and/or a voice user interface. Each alert may be generated upon obtaining notification of a risk associated with a user action on a computer system. In addition, the alert may notify a user of the risk and/or effect of performing the user action. For example, an alert may be generated and displayed to the user if the user attempts to download and install malware onto his/her computer.

More specifically, embodiments provide a method and system for generating alerts according to the severity of the risks associated with the user actions. Each alert may include a set of user-interface elements representing a risk and/or an effect of a user action. To respond to the alert, the user may drag a first of the user-interface elements in one or more directions to a second of the user-interface elements. The user-interface elements and direction(s) may be selected and/or arranged to reduce the user's habituation to such alerts. The user action may then be processed based on the user's response. For example, the user action may be completed if the response indicates the user's understanding of the risk and/or effect of the user action, while the user action may be discontinued if the response indicates the user's lack of understanding or willingness to proceed with the user action.

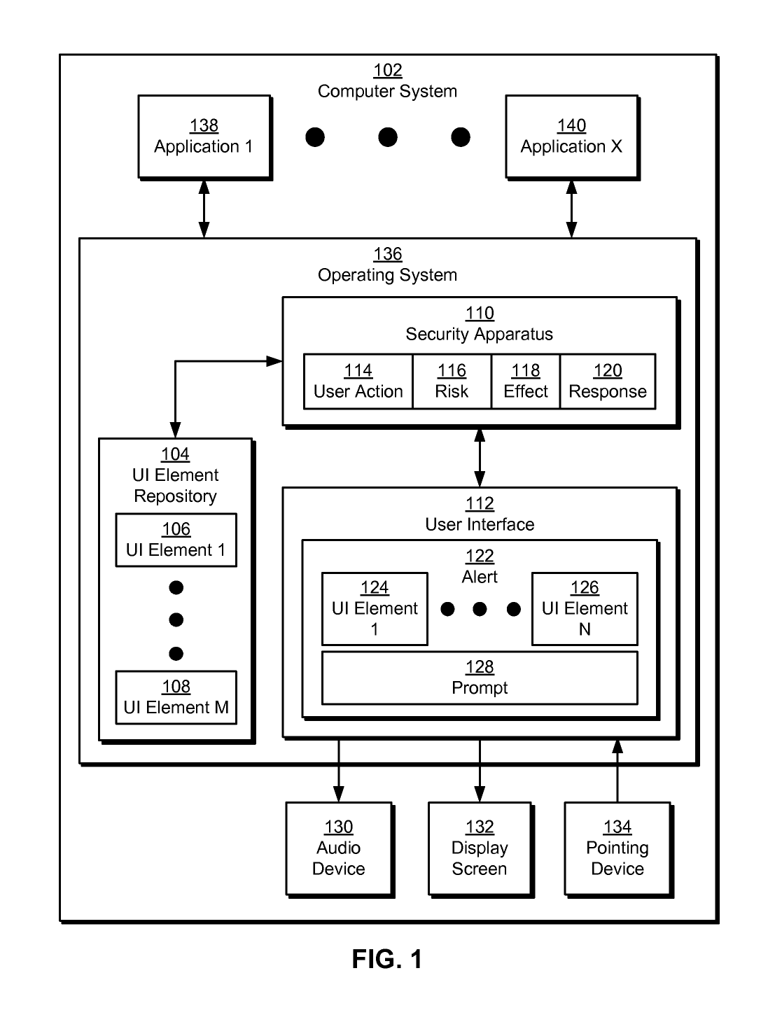

FIG. 1 shows a computer system 102 in accordance with an embodiment. Computer system 102 includes multiple applications (e.g., application 1 138, application x 140), an operating system 136, an audio device 130, a display screen 132, and a pointing device 134. Each of these components is discussed in further detail below.

Computer system 102 may correspond to an electronic device that provides one or more services or functions to a user. For example, computer system 102 may operate as a mobile phone, personal computer, global positioning system (GPS) receiver, portable media player, personal digital assistant (PDA), and/or graphing calculator. In addition, computer system 102 may include an operating system 136 that coordinates the use of hardware and software resources on computer system 102, as well as one or more applications (e.g., application 1 138, application x 140) that perform specialized tasks for the user. For example, computer system 102 may include applications such as an email client, an address book, a document editor, a tax preparation application, a web browser, and/or a media player. To perform tasks for the user, applications (e.g., application 1 138, application x 140) may obtain the use of hardware resources (e.g., processor, memory, I/O components, wireless transmitter, etc.) on computer system 102 from the operating system, as well as interact with the user through a hardware and/or software framework provided by operating system 136, as described below.

To enable interaction with the user, computer system 102 may include one or more hardware input/output (I/O) components, such as audio device 130, display screen 132, and pointing device 134. Each hardware I/O component may additionally be associated with a software driver (not shown) that allows operating system 136 and/or applications on computer system 102 to access and use the hardware I/O components.

Display screen 132 may be used to display images and/or text to one or more users of computer system 102. In one or more embodiments, display screen 132 serves as the primary hardware output component for computer system 102. For example, display screen 132 may allow the user to view menus, icons, windows, emails, websites, videos, pictures, maps, documents, and/or other components of a user interface (UI) 112 provided by operating system 136. Those skilled in the art will appreciate that display screen 132 may incorporate various types of display technology to render and display images. For example, display screen 132 may be a liquid crystal display (LCD), an organic light-emitting diode (OLED) display, a surface-conducting electron-emitter display (SED), and/or another type of electronic display.

Audio device 130 may produce audio output on computer system 102. For example, audio device 130 may correspond to a loudspeaker and/or a headset that is peripherally connected to computer system 102 or integrated within computer system 102. Audio device 130 may allow the user to listen to music, play movies with audio tracks, use text-to-speech functionality provided by operating system 136, and/or receive sound notifications from applications and/or operating system 136.

Pointing device 134 may function as a hardware input component of computer system 102. Specifically, pointing device 134 may allow the user to point to and/or select one or more areas of display screen 132 using a cursor, highlight, and/or other visual indicator provided by UI 112. Input entered by the user using pointing device 134 may be processed by the corresponding software driver and sent to operating system 136 and/or one or more applications (e.g., application 1 122, application x 124) as one or more actions. For example, pointing device 134 may be a mouse, a touch pad, a finger or a stylus on a touch-sensitive display (e.g., display screen 132), a trackball, a pointing stick, and/or a joystick.

Those skilled in the art will appreciate that other I/O devices (not shown) may exist on computer system 102. For example, computer system 102 may also include a keyboard, webcam, remote control, and/or one or more sets of device-specific buttons. Applications and/or operating system 136 may use the input from available input devices to perform one or more tasks, as well as update UI 112 in response to the input. Images and/or audio corresponding to UI 112 may be sent by the operating system to a device driver, which may display the images on display screen 132 as a series of pixels and/or produce audio playback on audio device 130. As a result, the user may interact with computer system 102 by using pointing device 134 and/or other input devices to provide input and receiving output through audio device 130 and/or display screen 132. In other words, UI 112 may correspond to a graphical user interface (GUI), a touch UI, and/or a voice UI.

In one or more embodiments, operating system 136 includes functionality to mitigate security risks on computer system 102. In particular, a security apparatus 110 in operating system 136 may obtain notification of a risk 116 associated with a user action 114 on computer system 102. User action 114 may be provided by the user through interaction with UI 112. For example, user actions on computer system 102 may correspond to the installation and/or use of applications, the sending and/or receiving of emails, the loading of webpages, the manipulation of data, and/or other types of interaction between the user and computer system 102. In addition, security apparatus 110 may generate an alert 122 within UI 112 based at least on the severity of risk 116. That is, the generation of alert 122 may be based on one or more factors that include the severity of risk 116. As discussed below, security apparatus 110 may vary the appearance of alert 122 according to the type, severity, and/or recurrence of risk 116.

In one or more embodiments, alert 122 includes a set of UI elements (e.g., UI element 1 124, UI element m 126) that represent an effect 118 of user action 114 on computer system 102. For example, one UI element may represent user action 114 and/or risk 116, another UI element may represent a result of carrying out user action 114, and a third UI element may represent a result of discontinuing user action 114. UI elements in alert 122 may be selected by security apparatus 110 from a larger set of UI elements (e.g., UI element 1 106, UI element m 108) in UI element repository 104. For example, UI elements in alert 122 and/or UI element repository 104 may correspond to icons, images, shapes, and/or other graphical objects that may be used by security apparatus 110 to communicate risk 116 and/or effect 118 to the user.

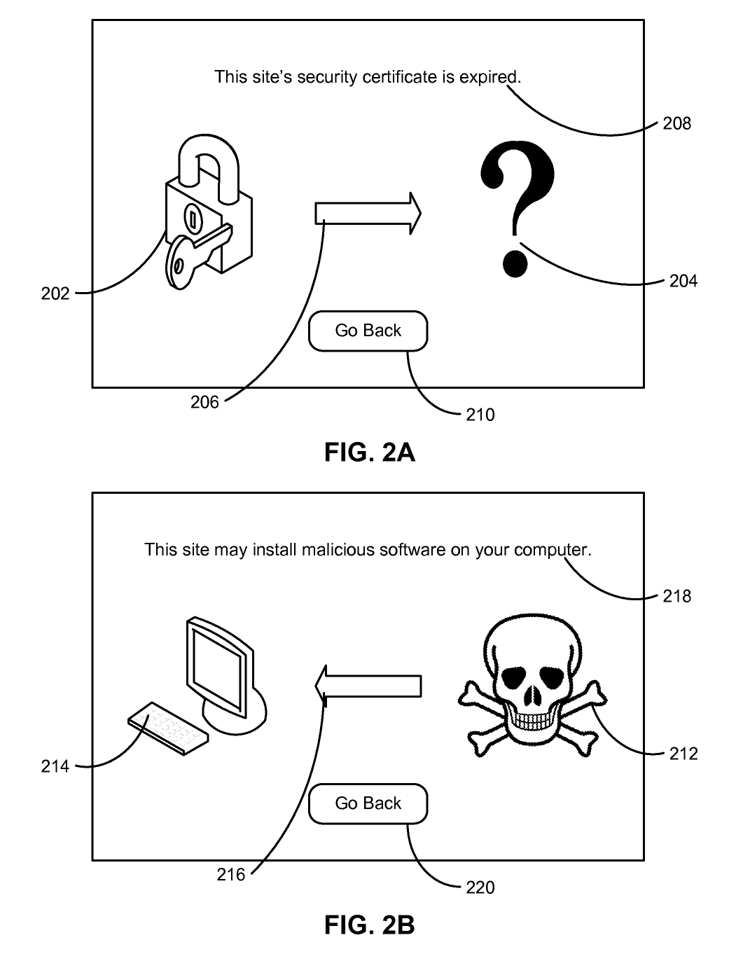

Consequently, alert 122 may be used to test the user's understanding of user action 114, risk 116, and/or effect 118. As shown in FIG. 1, alert 122 includes a prompt 128. In one or more embodiments, prompt 128 instructs the user to drag a first of the UI elements in alert 122 in one or more directions to a second of the UI elements in alert 122. As discussed below with respect to FIGS. 2A-2B, 3, and 4, prompt 128 may correspond to one or more arrows, a path, a voice prompt, and/or text instructions for interacting with UI elements in alert 122.

The user may provide a response 120 to alert 122 by following prompt 128 and/or otherwise interacting with UI elements in alert 122. For example, the user may indicate his/her understanding of risk 116 and/or effect 118 and complete user action 114 by dragging a first UI element representing user action 114 to a second UI element representing a completion of user action 114. Alternatively, the user may discontinue user action 114 by dragging the first UI element to a third UI element representing a discontinuation of user action 114.

Because security apparatus 110 may generate alerts according to the severity and/or nature of the associated risks, security apparatus 110 may mitigate user habituation to the same alerts and/or types of alerts. For example, security apparatus 110 may use different UI elements and/or prompts for different types and/or instances of user actions, risks, and/or effects. A higher-risk user action may require a more sophisticated and/or involved response 120 to alert 122, while a lower-risk user action may test the user's basic understanding of the user action's implications and/or effects. Similarly, security apparatus 110 may vary the appearances of alerts, even if such alerts are triggered by the same type of risk. For example, security apparatus 110 may generate different alerts for expired security certificates by using different UI elements to represent security certificates and/or prompt 128 in each alert. Risk-based alerts for user actions are discussed in further detail with respect to FIGS. 2A-2B, 3, and 4.

FIG. 2A shows an exemplary screenshot in accordance with an embodiment. More specifically, FIG. 2A shows a screenshot of an alert, such as alert 122 of FIG. 1. The alert includes a set of UI elements 202-210 corresponding to icons, shapes, images, text, and/or buttons. The alert may be displayed upon obtaining notification of a risk associated with a user action, such as a notification that a user is attempting to load a webpage with an expired security certificate.

In particular, UI element 202 may represent a security certificate, and UI element 204 may represent an unknown and/or uncertain state. UI element 208 may include text (e.g., “This site's security certificate is expired.”)

describing the nature of the risk and/or alert, and UI element 210 may be a button (e.g., “Go Back”) that allows the user to discontinue the user action that triggered the alert. The alert may also include a voice prompt (not shown) containing additional instructions and/or description of the user action, risk, and/or alert.

UI element 206 may correspond to a prompt in the alert, such as prompt 128 of FIG. 1. For example, UI element 206 may be a horizontal arrow from UI element 202 to UI element 204. Because the alert of FIG. 2A may correspond to a relatively low-risk user action, the user may be prompted to drag UI element 202 in a common direction (e.g., left-to-right) to UI element 204. As discussed below, alerts for higher-risk user actions may require the user to drag

UI elements in non-common directions and/or sequences of directions before allowing the user to proceed with the corresponding user actions.

As mentioned above, the alert may be used to test the user's understanding of the user action, risk, and/or effect of the user action. To proceed with the user action (e.g., loading a webpage with an expired security certificate), the user may drag UI element 202 to UI element 204 in the direction indicated by UI element 206 using a pointing device, touch-sensitive display, and/or other input device. Conversely, the user may discontinue the user action by selecting UI element 210.

FIG. 2B shows an exemplary screenshot in accordance with an embodiment. As with FIG. 2A, FIG. 2B shows a screenshot of an alert containing a set of UI elements 212-220. The alert may be displayed upon obtaining notification of a risk of malware installation on a computer system by the user. As a result, UI element 212 may represent a dangerous situation (e.g., computer system crash, theft of personal information, etc.) associated with the malware installation, UI element 214 may represent the computer system, and UI element 216 may represent a prompt to drag UI element 212 to UI element 214. UI element 218 may contain text (e.g., “This site may install malicious software on your computer.”) describing the risk and/or effect associated with the user action triggering the alert, and UI element 220 may be a button (e.g., “Go Back”) that the user may select to discontinue the user action.

As shown in FIG. 2B, UI element 216 may indicate a dragging of

UI element 212 to UI element 214 in a non-common (e.g., right-to-left) direction. The use of the non-common direction may mitigate user habituation to alerts in the computer system and/or enable differentiation between different types of risks. For example, the non-common direction within the alert of FIG. 2B may indicate a more severe risk than the risk associated with the user action of FIG. 2A. The non-common direction may also require the user to regard the alert more carefully than if a common direction (e.g., left-to-right) were used.

Along the same lines, the arrangement and/or appearance of UI elements 212-220 may change between instances of the alert to further reduce user habituation. For example, other instances of the alert may use an image of a broken computer system, a guillotine, and/or other representation of damage or destruction for UI element 212. On the other hand, UI element 214 may be varied to include an image of a hard drive, a credit card, and/or the user's picture to indicate the entity or party that is subject to the harmful effect. UI elements 212-214 may also change appearance as the user interacts with the alert. For example, the selection and/or dragging of UI element 212 may animate UI element 212 to emphasize the severity of the risk involved in the user action, while the overlapping of UI element 212 and UI element 214 may cause UI element 214 to change to an image of a broken and/or disassembled computer system.

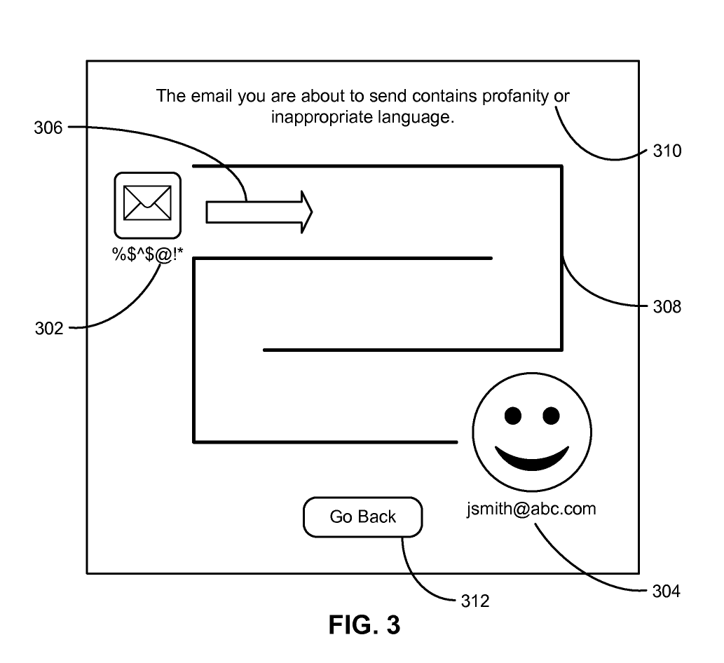

FIG. 3 shows an exemplary screenshot in accordance with an embodiment. As with FIGS. 2A-2B, the screenshot of FIG. 3 corresponds to an alert for a risk associated with a user action on a computer system. For example, the risk may correspond to profanity and/or inappropriate language in an email to be sent by a user of the computer system.

In particular, the alert contains a number of UI elements 302-312. UI element 302 may represent an email containing profanity and/or inappropriate language, UI element 304 may represent a recipient of the email and includes the recipient's email address (e.g., “jsmith@abc.com”), and UI element 306 may be a prompt to proceed with the user action (e.g., sending the email) by dragging UI element 302 to UI element 304. UI element 310 may include text describing the effect or risk of the user action (e.g., “The email you are about to send contains profanity or inappropriate language.”), and UI element 312 may correspond to a button (e.g., “Go Back”) that allows the user to discontinue the user action.

UI element 308 may correspond to a path through which the user must drag UI element 302 to reach UI element 304. In other words, the alert may require the user to drag UI element 302 in a sequence of directions to UI element 304 to complete the user action. The alert of FIG. 3 may thus require more of the user's attention than alerts that may be bypassed by dragging UI elements in only one direction. As discussed above, other changes in the appearance and/or arrangement of UI elements in the alert may additionally facilitate user attentiveness to the alert, even as multiple instances of the alert are displayed over time to the user.

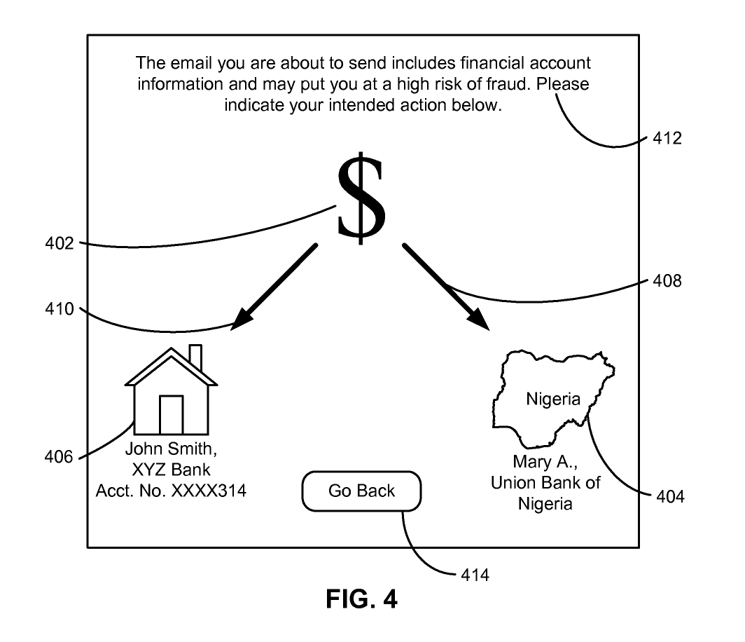

FIG. 4 shows an exemplary screenshot in accordance with an embodiment. The screenshot of FIG. 4 may correspond to an alert containing a set of UI elements 402-414. The alert may be generated and displayed upon obtaining notification of a risk associated with a user action. For example, the alert may be displayed upon obtaining a notification of a high fraud risk in the sending of an email containing financial account information to a recipient in Nigeria.

Within the alert, UI element 402 may represent an item (e.g., money) associated with the fraud risk, UI element 404 may represent one potential destination (e.g., “Mary A., Union Bank of Nigeria”) for the item, and UI element 406 may represent another potential destination (e.g., “John Smith, XYZ Bank, Acct. No. XXXX314”) for the item. UI elements 408-410 may correspond to prompts (e.g., arrows) to drag UI element 402 to either UI element 404 or UI element 406. UI element 412 may contain text (e.g., “The email you are about to send includes financial account information and may put you at a high risk of fraud.”) describing the risk and/or effect associated with the user action, as well as instructions (e.g., “Please indicate your intended action below.”) for the user. Finally, UI element 414 may correspond to a button (e.g., “Go Back”) that the user may select to cancel the user action.

The alert of FIG. 4 may thus test the user's understanding of the user action by providing a choice between two UI elements 404-406 to which the user may drag UI element 402 without providing an explicit explanation of the subsequent completion or discontinuation of the user action according to the user's response to the alert. For example, the user may drag UI element 402 to UI element 406 to discontinue the user action. On the other hand, the user may drag UI element 402 to UI element 404 to proceed with the user action (e.g., sending of the email). As such, the user may indicate a basic understanding of the potential consequences of sending or not sending the email by dragging UI element 402 to either UI element 404 or UI element 406.

The user may also be required to interact with other alerts to complete the user action. For example, the user may be presented with a series of alerts testing the user's understanding of the different risks, effects, and/or other aspects of the user action. Each alert may provide the user with multiple options; selection of most options in the alert may result in the discontinuation of the user action, while selection of one specific option may advance the user to the next alert. In other words, alerts for severe risks may be coupled to maintain the user's attention and/or fully test the user's understanding of the risks and/or consequences involved.

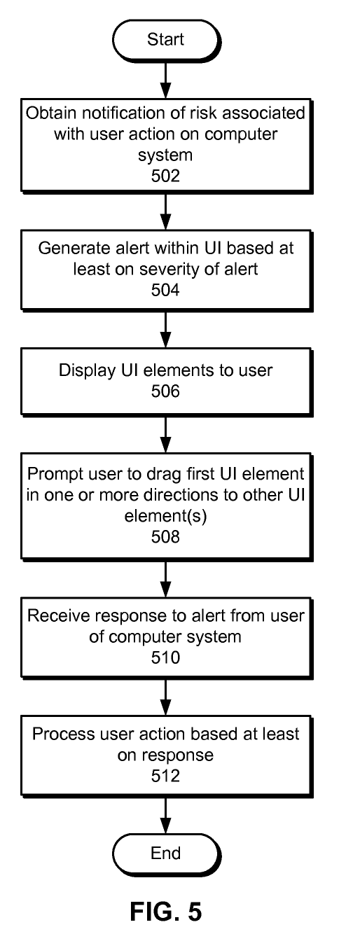

FIG. 5 shows a flowchart illustrating the process of facilitating use of a computer system in accordance with an embodiment. In one or more embodiments, one or more of the steps may be omitted, repeated, and/or performed in a different order. Accordingly, the specific arrangement of steps shown in FIG. 5 should not be construed as limiting the scope of the embodiments.

Initially, notification of a risk associated with a user action on a computer system is obtained (operation 502). The user action may correspond to the installation and/or execution of software, the sending of an email, the modification and/or deletion of a document, the loading of a webpage, and/or other user interaction with the computer system. Next, an alert is generated within a UI based at least on the severity of the alert (operation 504). The alert may contain a set of UI elements representing a risk and/or effect of the user action. The UI may correspond to a GUI, a touch UI, and/or a voice UI.

To provide the alert to a user of the computer system, the UI elements may be displayed to the user (operation 506), and the user may be prompted to drag a first of the UI elements in one or more directions to one or more other UI elements (operation 508). For example, the user may be prompted to drag the first UI element to a second UI element representing a completion of the user action and/or to a third UI element representing a discontinuation of the user action. Furthermore, the user may be prompted with little to no explanation to test the user's understanding of the risk and/or effect of the user action.

A response to the alert may then be received from the user (operation 510). The response may include the dragging of the first UI element to one of the other UI elements. Alternatively, the response may include the user's selection of a button that cancels the user action. Finally, the user action is processed based at least on the response (operation 512). For example, the user action may be completed if the UI element to which the first UI element is dragged represents a completion of the user action, while the user action may be discontinued if the UI element to which the first UI element is dragged represents a discontinuation of the user action.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for facilitating use of a computer system, comprising:
obtaining notification of a risk associated with a user action on the computer system;
generating an alert within a user interface based at least on a severity of the risk, wherein the alert comprises a set of user-interface elements representing an effect of the user action;
receiving a response to the alert from a user of the computer system, wherein the response comprises a dragging of a first of the user-interface elements in one or more directions to a second of the user-interface elements; and
processing the user action based at least on the response.

2. The computer-implemented method of claim 1, wherein generating the alert based at least on the severity of the risk involves:
displaying the user-interface elements to the user; and
prompting the user to drag the first of the user-interface elements in the one or more directions to the second of the user-interface elements.

3. The computer-implemented method of claim 2, wherein the one or more directions comprise:
a common direction;
a non-common direction; or
a sequence of directions.

4. The computer-implemented method of claim 2, wherein generating the alert based at least on the severity of the risk further involves:
prompting the user to drag the first of the user-interface elements in one or more directions to a third of the user-interface elements.

5. The computer-implemented method of claim 4,
wherein the second of the user-interface elements represents a completion of the user action, and
wherein the third of the user-interface elements represents a discontinuation of the user action.

6. The computer-implemented method of claim 1, wherein processing the user action based at least on the response involves:
completing the user action if the second of the user-interface elements represents a completion of the user action; and
discontinuing the user action if the second of the user-interface elements represents a discontinuation of the user action.

7. The computer-implemented method of claim 1, wherein the user interface corresponds to a graphical user interface (GUI), a touch user interface, or a voice user interface.

8. A system for facilitating use of a computer system, comprising:
a security apparatus configured to:
obtain notification of a risk associated with a user action on a computer system;
generate an alert based at least on a severity of the risk, wherein the alert comprises a set of user-interface elements representing an effect of the user action; and
process the user action based at least on a response to the alert; and a user interface configured to:
provide the alert to a user of the computer system; and
receive the response from the user, wherein the response comprises a dragging of a first of the user-interface elements in one or more directions to a second of the user-interface elements.

9. The system of claim 8, wherein generating the alert based at least on the severity of the risk involves:
displaying the user-interface elements to the user; and
prompting the user to drag the first of the user-interface elements in the one or more directions to the second of the user-interface elements.

10. The system of claim 9, wherein the one or more directions comprise:
a common direction;
a non-common direction; or
a sequence of directions.

11. The system of claim 9, wherein generating the alert based at least on the severity of the risk further involves:
prompting the user to drag the first of the user-interface elements in one or more directions to a third of the user-interface elements.

12. The system of claim 11,
wherein the second of the user-interface elements represents a completion of the user action, and
wherein the third of the user-interface elements represents a discontinuation of the user action.

13. The system of claim 8, wherein processing the user action based at least on the response involves:
completing the user action if the second of the user-interface elements represents a completion of the user action; and
discontinuing the user action if the second of the user-interface elements represents a discontinuation of the user action.

14. The system of claim 8, wherein the user interface corresponds to a graphical user interface (GUI), a touch user interface, or a voice user interface.

15. A computer-readable storage medium storing instructions that when executed by a computer cause the computer to perform a method for facilitating use of a computer system, the method comprising:
obtaining notification of a risk associated with a user action on the computer system;
generating an alert within a user interface based at least on a severity of the risk, wherein the alert comprises a set of user-interface elements representing an effect of the user action;
receiving a response to the alert from a user of the computer system, wherein the response comprises a dragging of a first of the user-interface elements in one or more directions to a second of the user-interface elements; and
processing the user action based at least on the response.

16. The computer-readable storage medium of claim 15, wherein generating the alert based at least on the severity of the risk involves:
displaying the user-interface elements to the user; and
prompting the user to drag the first of the user-interface elements in the one or more directions to the second of the user-interface elements

17. The computer-readable storage medium of claim 16, wherein the one or more directions comprise:
a common direction;
a non-common direction; or
a sequence of directions.

18. The computer-readable storage medium of claim 16, wherein generating the alert based at least on the severity of the risk further involves:
prompting the user to drag the first of the user-interface elements in one or more directions to a third of the user-interface elements.

19. The computer-readable storage medium of claim 18,
wherein the second of the user-interface elements represents a completion of the user action, and
wherein the third of the user-interface elements represents a discontinuation of the user action.

20. The computer-readable storage medium of claim 15, wherein processing the user action based at least on the response involves:
completing the user action if the second of the user-interface elements represents a completion of the user action; and
discontinuing the user action if the second of the user-interface elements represents a discontinuation of the user action.

21. The computer-readable storage medium of claim 15, wherein the user interface corresponds to a graphical user interface (GUI), a touch user interface, or a voice user interface.

22. A graphical user interface (GUI), comprising:
a set of user-interface elements representing an effect of a user action on a computer system, wherein the user action is associated with a risk; and
a prompt to drag a first of the user-interface elements in one or more directions to a second of the user-interface elements,
wherein the user action is processed based on a response to the prompt by a user of the computer system.

23. The GUI of claim 22, wherein the one or more directions comprise:
a common direction;
a non-common direction; or
a sequence of directions.

24. The GUI of claim 22, wherein the user action is processed by:
completing the user action if the second of the user-interface elements represents a completion of the user action; and
discontinuing the user action if the second of the user-interface elements represents a discontinuation of the user action.
